(19) United States
(12) Patent Application Publication
(10) Pub. No.: US 2002/0103065 A1
(43) Pub. Date: Aug. 1, 2002

(54) Method of and apparatus for producing bags from a double-layer synthetic resin film web

(75) Inventors: Armin Meyer, Koln (DE); Jakob Schneider, Niederkassel (DE)

Correspondence Address: THE FIRM OF KARL F ROSS, 5676 RIVERDALE AVENUE, PO BOX 900, RIVERDALE (BRONX), NY, 10471-0900, US

(73) Assignee: LEMO Maschinenbau GmbH

(21) Appl. No.: 10/058,633

(22) Filed: Jan. 28, 2002

Related U.S. Application Data
(60) Provisional application No. 60/265,296, filed on Jan. 31, 2001.

(30) Foreign Application Priority Data
Jan. 31, 2001 (DE) 10104506.9

(51) Int. Cl. B31B 1/36

(52) U.S. Cl. 493/81

(57) ABSTRACT

A bag-making method and apparatus in which the synthetic resin film web, folded to provide a double-layer is passed on a lower suction belt conveyor continuously through a weld station in which a plurality of separating weld elements at a right angle to the web weld respective seams and separate respective bags from the web. The conveyor is advanced with a stroke which is equal to the number of such elements times the bag width. A multi-belt suction conveyor above the lower conveyor picks up the bags and transfers them to a pin-collecting conveyor on which stacks of the bags are formed and on which pads can be produced from the stacks for transfer by a robot arm into packing cartons.

### CROSS REFERENCE TO RELATED APPLICATION

This is a nonprovisional application corresponding to provisional application 60/285,296 filed Jan. 31, 2001.

### FIELD OF THE INVENTION

Our present invention relates to a method and apparatus for the production of plastic bags from a double-layer synthetic resin film web. More particularly, the invention relates to an apparatus of the type in which the double-layer web is advanced stepwise through a welding station and the bags are formed by separating-welding elements which form seams and simultaneously separate the formed bags at the seams from one another.

### BACKGROUND OF THE INVENTION

The fabrication of plastic bags from double-layer webs by the formation of seams transversely to the path of the web and the direction of advance thereof, utilizing separating-welding elements which simultaneously form the seam by welding the two layers together and effect separation of the bags from the web at the seam are known.

It is also known to advance the web on a suction belt conveyor and to drive the latter in a stepwise manner so that the conveyor steps the bags and the web forwardly through the welding station. After the bags are formed they can be picked up by an upper suction belt conveyor and transferred to a stacking device. The systems which have been provided in the past for this purpose have utilized as the separating welding element, a welding beam which produces a side seam for the bag and simultaneously separates a previously-formed bag from the web. The length of each stroke of the stepped conveyor corresponds to the width of the bag produced and thus with each welding stroke, one bag is formed. When a bag is to be produced which has a closed bottom or a bottom seam, the double-layer web can be produced by folding a web of twice the bag length in the longitudinal direction. The longitudinal fold of the web can form a bottom folded back upon separation of the back from the web.

In German patent document 39 22 236 C2, a method and apparatus for producing bags is described in which two spaced-apart separating weld elements are used to form bags from a double-layer web. The two elements are inclined to the bag and are displaced synchronously up and down to produce the individual bags. In the welding station, the web and the bags formed therefrom lie upon suction belt conveyors, one of which is disposed between the two separating welding elements while the other connects to the first. The welding beams themselves act against counter-elements formed by respective rollers such that these rollers are provided between the suction belt conveyors.

Thus the path of the web and of the bags is defined by a number of suction belt conveyors and the rollers which function as counter-elements for the welding beams or bars. The apparatus has been used to produce so-called pointed bags with generally trapezoidal configuration. The first separating-welding element in the path separates a film segment with a parallelogrammatic outline from the web and this segment is then divided diagonally by another weld seam into two pointed bags. Neither the method nor apparatus described in this document is suitable for producing bags of rectangular configuration and the apparatus is expensive to produce.

### OBJECTS OF THE INVENTION

It is, therefore, the principal object of the present invention to provide an improved method of making bags or an improved method of operating a bag-making machine whereby the drawbacks of the earlier system can be avoided and a simpler, more economical and more reliable apparatus can be used.

Another object of this invention is to produce bags of rectangular configuration at increased production rates.

It is also an object of the invention to provide an improved apparatus for the making of bags which has a simpler construction than the earlier apparatus described.

### SUMMARY OF THE INVENTION

These objects and others which will become apparent hereinafter are attained, in accordance with the invention in a method of making plastic bags or a method of operating a bag-making machine which comprises the steps of:

(a) providing along a transport path a welding station having at least two spaced-apart elongated separation-welding elements extending at a right angle to the path and adapted to seam and to separate a bag from the web between the separation-welding elements;

(b) advancing a double-layer synthetic resin film web and bags separated therefrom stepwise forwardly through the transport path on a first suction belt conveyor which is continuous at least over a length of the first suction belt conveyor encompassing all of the separation-welding elements at a certain stepping frequency and synchronously actuating the separation-welding elements in step with advance of the first suction belt conveyor to seam and separate individual bags from the web and advance the web and the bags on the suction belt conveyor;

(c) controlling a step length of each advance of the suction belt conveyor so that the step length is equal to a product (n×w) of the number (n) of the separation-welding elements and the width (w) of the bags;

(d) picking up the bags from the suction belt conveyor at a location downstream of the welding station with a second suction belt conveyor disposed above the first suction belt conveyor; and

(e) advancing the second suction belt conveyor synchronously with stepping frequency of the first suction belt conveyor.

More specifically the web and the bags separated from the web are supported in the welding station, in accordance with the invention, on a single suction conveyor belt which is not subdivided in its length or intercepted at least over the span encompassed by all of the separating welding elements which separate the bags from the web at the weld seams. The separating-welding elements themselves run at a right angle to the web. The web in the welding station is advanced with a stroke or step length which is the product of the number of such separating welding elements and the bag width and downstream of the welding station the bags are picked up for stacking by an upper suction belt conveyor which is stepped vertically synchronously with the stepping or cycling frequency of advance in the welding station.

Thus with each advance of the conveyors a number of bags can be separated from the web which can correspond in number to the number of separating welding elements which are vertically displaced synchronously with the bag advance, simultaneously and synchronously with the upper suction belt conveyor which simultaneously picks up the bags formed and carries them away.

According to another aspect of the invention, an apparatus for practicing the method of the invention or an apparatus upon which that method is practiced can comprise a feed unit which can advance a web and the bags separated from the web from an input station upstream of the welding station and through the welding station in a stepwise manner. The welding station can then comprise at least two spaced-apart supporting welding elements or bars which can be synchronously displaced up and down and are spaced in the direction of advance of the web but can extend transversely of the web.

The path is defined by the first suction belt conveyor on which bags and the web are advanced stepwise in a forward direction and above this belt is a second or upper suction belt conveyor which serves to pick up the bags formed by the separation welding elements from the first or underlying suction belt and carry the bags to a stacking unit or device which is downstream of the welding station.

According to the apparatus aspects of the invention, therefore, all of the separating welding elements of the welding station run at a right angle to the web, the first or lower suction belt is uninterrupted or continuous over its length in the welding station at least in its region spanned across all of the separating welding elements which are provided and the upper suction belt conveyor is advanced synchronously with the stepping frequency of the feed unit in a forward direction and thus picks up the bags and carries them from the welding station in the cadence of the feed frequency of the lower conveyor and the advance of the bags thereon.

According to a feature of the invention the number of separating welding elements in the welding station is two and two bags are formed simultaneously with each stroke of the two separating welding elements.

According to another feature of the invention, the lower suction belt extends to a region beneath the upper suction belt conveyor.

Advantageously, the stacking or accumulating unit for the bags is a pin stacker, the pins of which engage in holes in the bags.

The stacker or padder which can form pads of the bags, can include a further belt which extends into a region beneath the upper suction belt conveyor and upon which the bags are deposited from the upper suction belt conveyor.

The apparatus can include a knock-off device at an end region of the upper suction belt conveyor which can press the bags downwardly therefrom.

The knock-off device can comprise vertically movable pressure pads which can dispose between the belts of the suction belt conveyor. Indeed, each of the suction belts or suction belt conveyors which have been described herein can comprise a single suction belt or a plurality of mutually parallel transversely-spaced suction belts.

### BRIEF DESCRIPTION OF THE DRAWING

The above and other objects, features, and advantages will become more readily apparent from the following description, reference being made to the accompanying drawing in which:

FIGS. 1A and 1B are respective side elevational views of a bag-making apparatus according to the invention subdivided longitudinally to permit the Figures to be enlarged;

FIG. 2 is an enlarged detail of the region between the welding station and the collecting station of the bag-making machine;

FIG. 3 is a side elevational view of the knock-off device; and

FIG.4 is a transverse section through the knock-off device of FIG. 3.

### SPECIFIC DESCRIPTION

The machine shown in the drawing serves for the production of plastic bags with rectangular cross section and especially for bags which can be used in packaging machines for the packaging of bread and also in the hygienic field. The synthetic resin web is continuously withdrawn by an unwinding apparatus from a roll suspended in the unwinding unit and is folded along a longitudinal fold line in a folding device 1. The folded synthetic resin foil is thus a double-layer film which can, in the embodiment illustrated, also have an additional fold extending in the longitudinal direction so that the web is four layered in the region of the bag bottoms. The term “four-layered” web thus encompasses two-layer webs.

Following the folding unit 1, the machine of the invention is provided with a feed and intermediate storage unit 2 which, on the one hand, continuously draws the folded web from the folding unit 1 and, on the other hand, advances the web in sections in a stepwise manner with a certain cadence for cycling frequency. The intermediate storage device can have so-called compensating records which, during a standstill of the feed, take up the continuously received web and store the latter during a swinging movement of a rocker and, upon the advance of the web, draws the web from the loop formed by the rocker.

Connected to the feed and intermediate storage device 2 is a prewelding unit 3 with two prewelding elements or bars which at the spacing of the bag width and a multiple thereof are arranged one after the other along longitudinal sides of the machine at which the bottom folds are to be defined in the respective bags. The two prewelding elements 3.1 and 3.2 heat the web in four layered regions of the bottom folds and thus ensure that these thickened regions will be seamed and separated in the subsequent subdivision of the web into bags. A feed unit 4 follows the prewelding unit 3 and advances the web in a stepwise manner into and through a subsequent welding station 5. The feed unit 4 can include transport rollers constituting feed elements. In addition, the web rests upon the suction belt 6 which is advanced in a stepwise manner in the forward direction by belt drive 15. The suction belt extends through and beyond the welding station 5.

The welding station 5 comprises at least two separation-welding elements or bars 8 which are spaced from one another in the travel direction of the web and extend at a right angle to the web, substantially over the entire machine width. Preferably the welding station has two such separating welding elements 7, 8. It is, however, possible to provide three or four separating welding elements, a corresponding number of bags are formed. In these embodiments the number of prewelding elements should correspond to the number of separating welding elements.

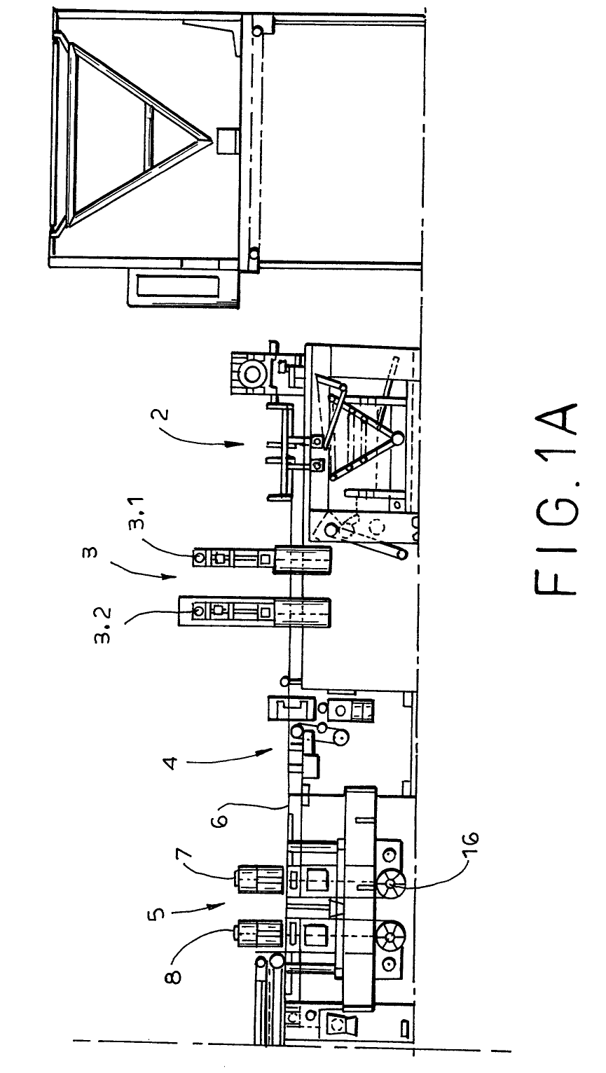

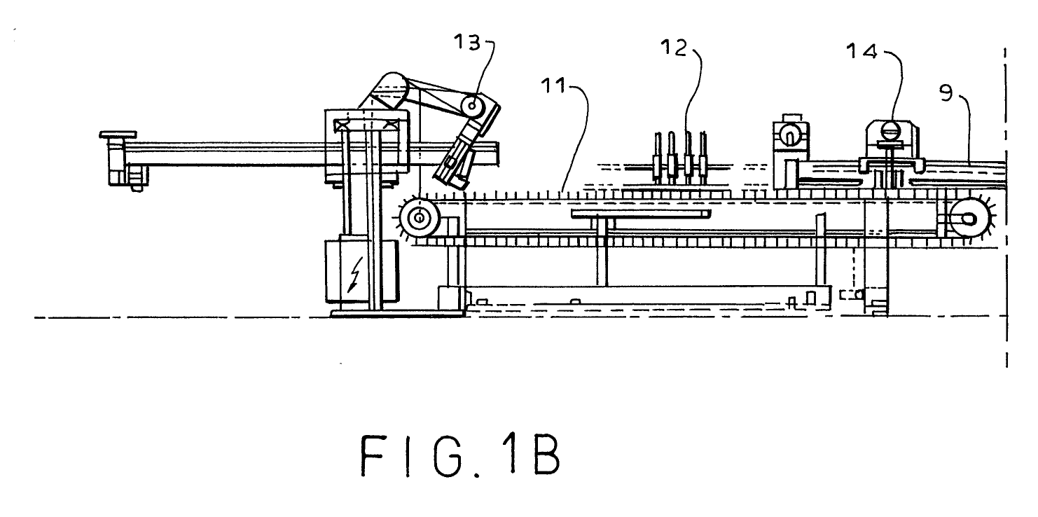

The spacing of the separating welding elements 7 and 8 from one another corresponds to the width of a bag or a multiple of the width of a bag. The separating welding elements are raised and lowered synchronously with the cycling frequency of the stepped advance of the conveyer belt 6, i.e. of the periodic feeder 4 and serve to form the bag seams and separate the individual bags form one another from the web along the sides of the bags. Preferably the separating welding elements 7 and 8 are welding beams which form the seams and separate the bags form each other and the web by heating. The spacing of the separating welding elements 7 and 8 from one another is adjustable so that bags of different widths can be fabricated. The drive for vertically displacing the separating welding elements 7,8 has been represented at 16 in FIGS. 1A and 1B.

The suction belt 6 which is located below the transport path of the web and supports the web and the bags, extends in its length without interruption at least over the region encompassing all of the separating welding elements of the welding unit 5 and, in the embodiment shown, at least encompassing the two separating welding elements 7 and 8.

The suction belt 6 extends at least to a point below the upper suction belt conveyor 9 which serves to pick up the bags as they are separated from the web.

The suction belt 6 preferably extends, in its width, over the entire machine width. At least the pass of that belt which receives the web is formed with a multiplicity of suction openings which passes over a suction box, the latter being evacuated to draw the web and the bags on the belt 6 against the latter and to hold the bags and the web on this belt. The suction belt 6 has its own drive 10 and advances the box stepwise. The belt 6, because it serves as a counter surface for the separating welding elements 7 and 8, is composed of a temperature resistant material, preferably polytetrafluoroethylene (Teflon). Supports in the region of elements 7 and 8 are formed by bars over which the upper conveying pass of the suction belt 6 travels and which extends transversely to the belt over the full machine width and support the belt to form the side seam of the bag and against the bag-separating forces applied by the elements 7 and 8.

The bars themselves can be composed of rubber and can have layers of temperature-resistant material on their surfaces, i.e. can be provided along their upper surfaces with layers of polytetrafluoroethylene. The configuration of the belt 6 which has a full width conveyor has the advantage that the stepping of the bags is effected with support of the latter over their full heights regardless of the bag size.

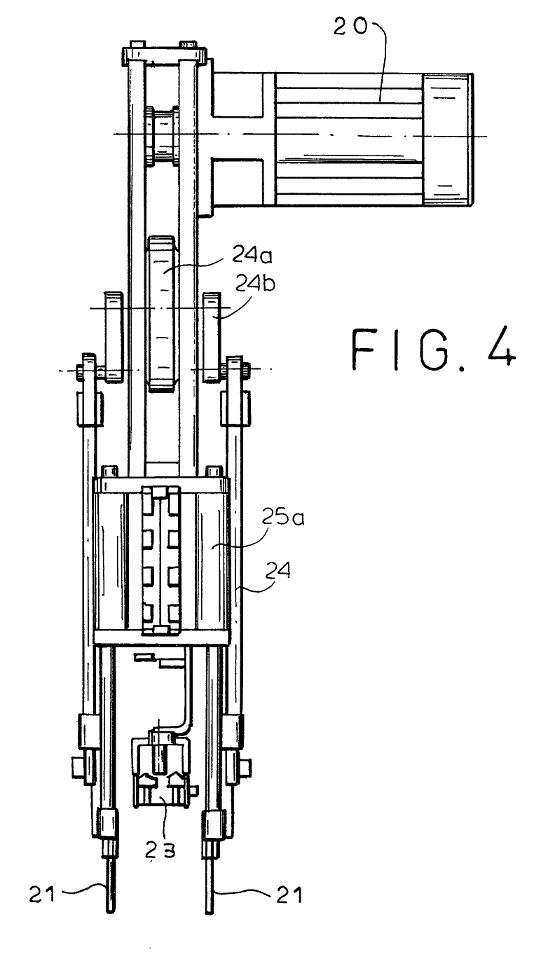

The bags carried by the suction belt 6 away from the welding station 5 are picked up by the upper suction belt conveyor 9 and, suspended from the latter, are carried to the collecting unit 11. The upper suction belt conveyor 9 can be comprised of a plurality of belts 22 which are spaced from one another with slight spacings and are individual endless belts, each of which can have a row of suction openings guided under respective suction boxes. A drive 17 is provided to step the suction belt conveyor 9 with a forward movement of a stroke frequency and step length corresponding to that of the belt 6. So that the bags hang from the lower conveying pass of this conveyor, the suction passages or boxes 23 are connected to a suction blower (FIG. 4). The latter generates the requisite suction at the suction openings to pull the bags up against the conveyor 9 as the suction at the belt 6 is shut off at the stroke cadence in the transfer region.

To enable the bags to be released from the suction belt conveyor 9 at the subsequent collecting unit 11, the suction belt conveyor 9 has a slider which can close the suction openings cyclically to interrupt the suction force.

The collecting unit 11 is preferably formed as a so-called pin stacker which, in a conventional manner, comprises a driven belt 18 which is cyclically displaced and on which respective pairs of pins 19 project from respective collecting plates on which the bags are stacked to respective pads. Such a pin stacker is known from WO 00/123 00. The belt 18 of the pin stacker extends to a region below the suction belt conveyor 9. The stacks of bags on the pin stacker 11 are bonded together to form pads at the padding station 12 as has been described in WO 00/123 00 and the pads are then picked up by a gripper hand of a robot 13, removed from the stacking pins and packed in cardboard boxes.

So that the bags will be reliably removed from the suction belt conveyor 9 and placed upon the pins of the pin-stacking device 11, the terminal region of the suction belt conveyor 9 is provided with a knock-off device 14 by means of which the bags are mechanically pressed downwardly onto the pins of the stacking device 11.

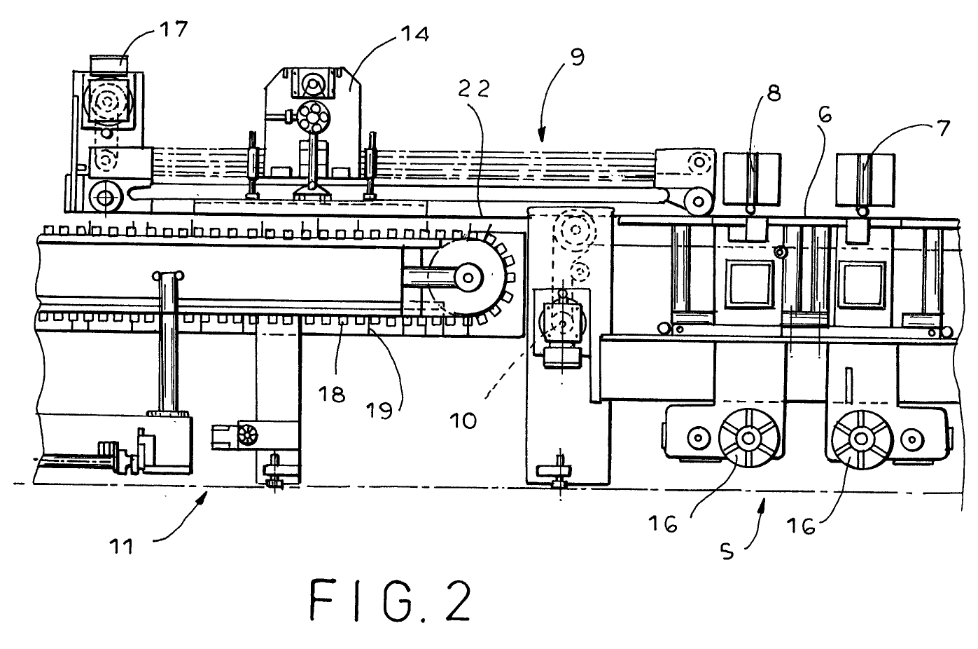

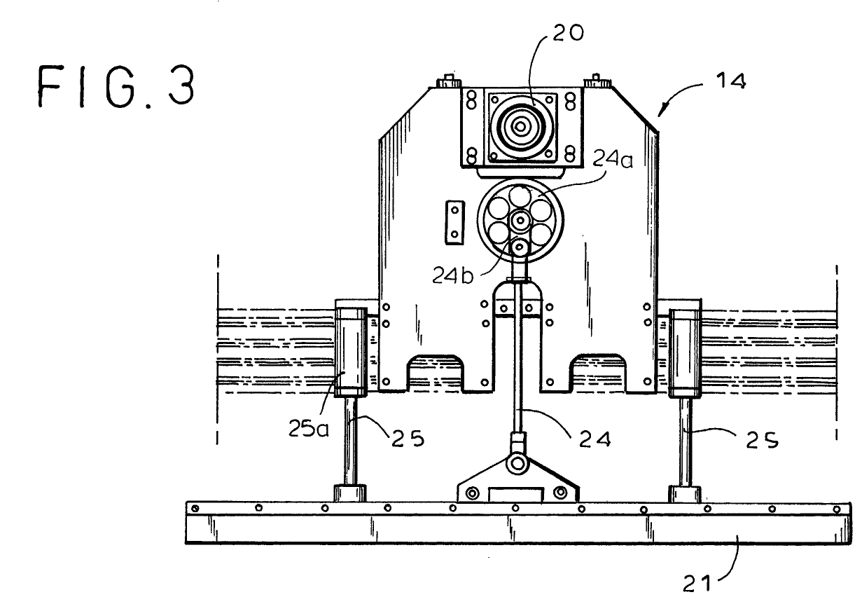

The knock-off device 14 shown in a reduced scale in FIG. 2 has been illustrated to a larger scale in FIGS. 3 and 4. The knock-off device can be provided with a pneumatic actuator or, as illustrated, a servomotor 20 for vertically driving the pressing pads 21 which are arranged between the belts 22 of the suction belt conveyor 9. Each of the pressing pads 21 is at the end of a crank linkage terminating in a rod 24. That linkage has been illustrated diagrammatically to include a sprocket wheel 24a which can be driven by a chain from a sprocket wheel of the servomotor 20, the wheel 24a being connected to a pair of cranks 24b to which the rod 24 for each of the pressing pads 21. The pads 21, in addition are guided on opposite sides of the crank rod 24 by guide rods 25 slidable in the guides 25a. The pressing pads 21 are shaped like skids and can extend over a substantial portion of the terminal part of the belt conveyor 9 between the belts 22 thereof. The pressure pads 21 are thus precisely displaceable from a location above the lower pass of the belts 22 of the suction belt conveyor 9 substantially to the level of the pins 19 and thus press the bags onto these pins directly. In the embodiments of FIGS. 3 and 4, two pressing pads 21 have a common drive 20. It has been found to be advantageous to provide the pressing pads 21 similarly in pairs with each pair of them having a common drive and straddling one of the belts 22 of the suction belt conveyor 9. Preferably the widths of the pressing pads 21 are so dimensioned that they span the space between two belts 22.

In the bag production method according to the invention, the plastic film web is continuously withdrawn from a roll and folded in the folding unit 1 so that it has a central longitudinal fold and additional bottom folds or a single additional bottom fold. The web thus can leave the folding unit 1 so that it is a two-layer web over substantially the entire width except for the bottom at which it is a four-layer fold.

Via the advancing unit 4 and the intermediate storage unit 2, the web is stepped with a frequency and a length of advance into successive stations corresponding to the bag width. The stepping frequency is synchronized with the operations of the prewelding device 2, the welding station 3 and the suction belt pickup 9. During a standstill, the prewelding step is effected at 2, the seaming and separation are effected at the welding station 5 and transfer of previously completed bags is effected where the suction belt conveyor 9 overhangs the conveyor 6.

The length of the advanced step is equal to the number of bags formed at each stroke in the welding station times the bag width or as the product of the number of separating welding elements times the bag width. Preferably two separating welding elements are used and the step length of the conveyor stroke is twice the bag width.

Both the spacing of the prewelding elements 3.1 and 3.2 from one another and the spacing of the separating weld elements 7, 8 from one another are equal to the bag width or a multiple thereof. With large bag widths, the spacing can be equal to the simple bag width.

As noted, in the prewelding device 3, a prewelding is carried out in the four layer region of the bottom so that the later seaming and separating weld action can be effected more readily, i.e. the weld seam in the four layer region is facilitated by the heating thereof.

The separating welding elements 7 and 8 then subdivide the web into individual segments corresponding to respective bags while forming the lateral seams thereof. Since the web and the bags on the conveyor 6 are advanced by twice the bag width, with each stroke of the conveyors and each stroke of the welding elements, two bags of rectangular form are produced with each stroke. In the same time as a single bag was produced with a single weld beam machine, two or more bags can be produced with the machine of the present invention and with each stroke two or more bags can be picked up by the suction belt conveyor 9 and deposited on the pins of the stacker. Preferably the stroke length of the suction belt 6 is slightly greater than twice the bag width so that upon displacement of the bags on the conveyor away from the welding station 5, a slight gap is produced between the two bags. This helps in ensuring that the bags will be reliably separated at their separating lines. During the transport on the suction conveyor 6, the bags which are produced and the web is held by suction against the conveyor.

The individual bags are pressed onto the pins of the stacking device 11 by the knock-off unit 14 previously described and are carried to the stacking unit 11 on the suction belt conveyor 9 where they are held by suction. The suction conveyor 9 is operated synchronously with the stroke of the conveyor 6 and the elements 7 and 8 in the welding station and the stroke length of the conveyor 9 can extend to the stroke length in the welding station 5 or can be slightly greater to maintain the slight spacing between the bags. The pickup of the bags from the conveyor 6 is effected during standstill of the latter and at an instant in time when the suction at the conveyor 6 is turned off. At the next standstill of the conveyor 9, the bags are transferred to a stacker 11 and the suction at the conveyor 9 is turned off by blocking the suction openings of the belts 22 at the discharge end of the conveyor 9. The pads 21 are pressed downwardly so that the holes in the bags are pressed over the upstanding pins of the stacker 19. The belt 18 of the stacker 11 remains stationary until two complete stacks of bags are accumulated and then advances these bags to a padding station at which the bags of the stacks are joined together. The pads can then be engaged by the gripper of a robot 13 which places them in the cartons.

We claim:

1. A method of making bags, comprising the steps of:
(a) providing along a transport path a welding station having at least two spaced-apart elongated separation-welding elements extending at a right angle to said path and adapted to seam and to separate a bag from said web between said separation-welding elements;
(b) advancing a double-layer synthetic resin film web and bags separated therefrom stepwise forwardly through said transport path on a first suction belt conveyor which is continuous at least over a length of said first suction belt conveyor encompassing all of said separation-welding elements at a certain stepping frequency and synchronously actuating said separation-welding elements in step with advance of said first suction belt conveyor to seam and separate individual bags from said web and advance said web and said bags on said first suction belt conveyor;
(c) controlling a step length of each advance of said suction belt conveyor so that said step length is equal to a product (n×w) of the number (n) of said separation-welding elements and the width (w) of said bags;
(d) picking up said bags from said first suction belt conveyor at a location downstream of said welding station with a second suction belt conveyor disposed above said first suction belt conveyor; and
(e) advancing said second suction belt conveyor synchronously with stepping frequency of the first suction belt conveyor.

2. The method defined in claim 1 wherein said second suction belt conveyor is advanced with a stroke length per advance which corresponds to that of said first suction belt conveyor or is slightly greater than the stroke length of said first suction belt conveyor.

3. The method defined in claim 1 wherein said bags are collected from said second suction belt conveyor on a collecting device having an endless belt extending partly beneath a region of said second suction belt conveyor.

4. The method defined in claim 3 wherein said bags are mounted on pins of said collecting device.

5. The method defined in claim 4 wherein said bags are pressed onto said pins mechanically.

6. The method defined in claim 5, further comprising the step of padding said bags in stacks on said pins to form respective pads of said bags.

7. The method defined in claim 6, further comprising the step of transferring said pads by a robot from said collecting device to packing cartons.

8. The method defined in claim 1 wherein said bags are seamed and separated in said welding station by two of said separation-welding elements.

9. An apparatus for making bags from a synthetic resin film in the form of a double layer web, said apparatus comprising a first suction belt conveyor receiving said web and transporting said web along a transport path;
a welding station along said path having at least two spaced-apart elongated separation-welding elements extending at a right angle to said path and adapted to seam and to separate the bag from said web between said separation welding elements, said separation welding elements extending at a right angle to said path;
a second suction belt conveyor downstream of said welding station and disposed above said first suction belt conveyor for picking up said bags from said first suction belt conveyor; and
drives for said first and second suction belt conveyors for stepping said bags and said web along said first suction belt conveyor and said bags with said second suction belt conveyor synchronously with the stepping of said first suction belt conveyor, said first suction belt conveyor extending without interruption over an entire region encompassing the separation welding element of said welding station.

10. The apparatus defined in claim 9 wherein said welding station is provided with two of said separation welding elements.

11. The apparatus defined in claim 10 wherein said suction belt conveyor extends beneath said second suction belt conveyor.

12. The apparatus defined in claim 11, further comprising a pin-stacking device downstream of said welding station and receiving said bags from said second suction belt conveyor.

13. The apparatus defined in claim 12 wherein said stacking device comprises a belt provided with pins for receiving stacks of said bags and advancing said stacks of bags.

14. The apparatus defined in claim 13, further comprising a knock-off device at an end of said second suction belt conveyor for pressing said bags downwardly onto pins of said pin-stacking device.

15. The apparatus defined in claim 14 wherein said knock-off device comprises vertically movable pressing pads disposed between parallel belts of said second suction belt conveyor.

16. The apparatus defined in claim 15 wherein said first suction belt conveyor is a single belt extending at least a full width of said web.
